(19) United States
(12) Patent Application Publication
(10) Pub. No.: US 2025/0222751 A1
(43) Pub. Date: Jul. 10, 2025

(54) LARGE PLATE FIXING DEVICE AND CAR COVER WITH SUCH FIXING DEVICE

(71) Applicant: NINGBO CROSSTRIP ELECTRONIC SCIENCE CO., LTD, NINGBO (CN)

(72) Inventor: Shiqi ZHENG, NINGBO (CN)

(21) Appl. No.: 18/967,664

(22) Filed: Dec. 4, 2024

(30) Foreign Application Priority Data
Jan. 8, 2024 (CN) 202420039441.1

(51) Int. Cl. B60J 7/04

(52) U.S. Cl. CPC B60J 7/04

(57) ABSTRACT

The present invention discloses a large plate fixing device, which comprises a first large plate fixing block, a second large plate fixing block, and a T-shaped rod. The first large plate fixing block is provided with an insert block positioning groove and an insert block, and the insert block is used to connect a guide rail. In the present invention, an insert block positioning groove is arranged on the first large plate fixing block, and a fixing protrusion is arranged on the second large plate fixing block. The cooperation between the fixing protrusion and the insert block positioning groove is utilized to limit the position of the car cover.

### CROSS-REFERENCES TO RELATED APPLICATIONS

The present disclosure claims the priority of Chinese Patent Application No. 202420039441.1, filed on Jan. 8, 2024, the entireties of which are herein incorporated by reference.

### FIELD

The present invention belongs to the field of automobile accessories, and specifically relates to a large plate fixing device and a car cover with this fixing device.

### BACKGROUND

Pickup trucks are one of the commonly seen automobiles in daily life. Pickup trucks have the advantages of comfort, stability, and being capable of transporting goods, etc., and are an indispensable part of the automobile market. The rear compartment, as the most prominent feature of pickup trucks, is mostly used for transporting goods.

Existing pickup trucks are gradually being equipped with some car covers to facilitate use in rainy and snowy days. Car covers are basically divided into soft covers and hard covers. Soft covers use waterproof leather to keep out the rain, while hard covers use sheet materials to form the car cover to keep out the rain. Compared with soft covers, hard covers have a certain strength, but their connection structures are relatively complex. The cover plates at different positions need to be opened frequently in some cases and not so frequently in others. Therefore, different connection structures need to be designed to meet different requirements.

During the actual use process, the large plate on the side close to the front of the vehicle usually does not need to be opened, and only the stability of its connection needs to be ensured. Most of the existing connection structures for large plates are to add a connecting piece on the large plate and then tighten it with a screw rod. This structure is prone to displacement during use and cannot provide good stability.

### SUMMARY

In order to overcome the deficiencies of the existing technology, the purpose of the present invention is to provide a large plate fixing device and a car cover with this fixing device. By changing the fixing structure of the large plate, the stability of the connection of the large plate can be ensured, and the stability of the entire car cover can be ensured, so as to solve the above problems.

To solve the above problems existing in the existing technology, the technical scheme adopted by the present invention is as follows:

A large plate fixing device, it comprises a first large plate fixing block, a second large plate fixing block and a T-shaped rod;

The first large plate fixing block is provided with an insert block positioning groove and an insert block, and the insert block is used to connect a guide rail;

The second large plate fixing block is provided with a clamping part and a fixing protrusion, the clamping part is used to connect a car cover, and the fixing protrusion extends into the insert block positioning groove for lateral positioning;

The T-shaped rod passes through the first large plate fixing block and the second large plate fixing block, and the T-shaped rod is connected with a plum blossom nut.

By setting a first large plate fixing block and a second large plate fixing block, the first large plate fixing block is connected to the guide rail, and the second large plate fixing block is connected to the large plate of the car cover, thereby connecting the large plate to the guide rail. An insert block positioning groove is set on the first large plate fixing block, and a fixed protrusion is set on the second large plate fixing block. The cooperation between the fixed protrusion and the insert block positioning groove is utilized to limit the position of the car cover.

Since the large plate usually does not need to be opened, the connection of the large plate mainly considers the stability and firmness of the connection, without considering the problem of convenient opening.

Furthermore, the first large plate fixing block further comprises a tensioning hole; the second large plate fixing block further comprises a claw, and in the middle of the claw is arranged a fixing block gap; the T-shaped rod comprises a square head and a threaded section, the square head is clamped to the claw, and the square head passes through the fixing block gap and the tensioning hole, a tensioning hole is set on the first large plate fixing block, and a claw is set on the second large plate fixing block. The square head of the T-shaped rod is hooked by the claw. The T-shaped rod passes through the gap of the fixing block and the tensioning hole. Finally, a plum blossom nut is connected to the T-shaped rod. By screwing the plum blossom nut, the first large plate fixing block and the second large plate fixing block are tightened.

Furthermore, the tensioning hole includes a long hole and a half-round hole. The long hole and the half-round hole are connected. The long hole is used for the square head of the T-shaped rod to pass through. After passing through the long hole, the square head needs to be moved to the claw. At this time, the T-shaped rod moves to the half-round hole. Finally, just connect the plum blossom nut.

A car cover it comprises a plurality of cover plates. The cover plates include large plates, medium plates and small plates. Two adjacent cover plates are connected by a rotating rod. The large plate is glued with a first large plate fixing rod. The first large plate fixing rod is provided with a large plate fixing groove, and both ends of the large plate fixing groove are connected with large plate fixing devices, is composed of multiple cover plates. The cover plates are rotationally connected with each other through the rotating rod. The first large plate fixing rod is glued to the bottom of the large plate. Different positions can be selected for installation according to requirements. It is not only convenient to connect but also firmly connected with good stability.

Furthermore, the rotating rods include a first large rotating rod, a second large rotating rod and a small rotating rod. According to the different widths of the cover plates, rotating rods of different sizes can be selected. The different sizes of the rotating rods here mainly refer to the different widths of the rotating rods. The large plate is also glued with a second large plate fixing rod. By setting two large plate fixing rods, four-point positioning is formed on both sides of the large plate to ensure the stability of the large plate. The structure of the second large plate fixing rod can be the same as or different from that of the first large plate fixing rod.

Furthermore, the cover plate also includes a secondary plate, the car cover also includes a guide rail. The guide rail is connected to the vehicle bucket through a clamping component. The guide rail is provided with a guide rail groove, and the car cover is connected to the guide rail through the insert block, the first large plate fixing block is connected to the guide rail by screw, and the screw pass through the threaded hole, the first large plate fixing block can slide within the guide rail. After the specific installation position is determined, the first large plate fixing block can be fixed to the guide rail by means of fastening.

The beneficial effects of the present invention are as follows:
1. In the present invention, by setting the first large plate fixing block and the second large plate fixing block, the car cover and the side rail are connected by using the two large plate fixing blocks, ensuring the stability of the connection of the car cover.
2. In the present invention, by setting the claw on the second large plate fixing block and also on the first large plate fixing block, it can not only play a tightening role but also have a certain anti-falling-off effect.

### BRIEF DESCRIPTION OF THE DRAWINGS

FIG. 1 is the first schematic structural diagram of the car cover in the present invention.

FIG. 2 is a partial enlarged view of part A in FIG. 1.

FIG. 3 is a partial enlarged view of part B in FIG. 1.

FIG. 4 is the second schematic structural diagram of the car cover in the present invention.

FIG. 5 is a partial enlarged view of part C in FIG. 4.

FIG. 6 is the first schematic structural diagram of the first large plate fixing block.

FIG. 7 is the second schematic structural diagram of the first large plate fixing block.

FIG. 8 is the third schematic structural diagram of the first large plate fixing block.

FIG. 9 is the schematic structural diagram of the second large plate fixing block.

FIG. 10 is the schematic structural diagram of the T-shaped rod.

In the figures: 1—First large rotating rod; 2—Second large rotating rod; 3—Small rotating rod; 4—Large plate fixing rod; 41—Large plate fixing groove; 42—Second large plate fixing block; 4201—Claw; 4202—Fixed protrusion; 4203—Positioning hole; 4204—Clamping part; 4205—Fixing block gap; 43—First large plate fixing block; 4301—Insert block positioning groove; 4302—Long hole; 4303—Half-round hole; 4304—Insert block; 4305—Threaded hole; 44—T-shaped rod; 4401—Square head; 4402—Threaded section; 45—Plum blossom nut; 6—Large plate; 61—Large plate groove; 7—Secondary plate; 8—Medium plate; 9—Small plate; 10—Guide rail; 101—Guide rail groove.

### DETAILED DESCRIPTION OF THE DISCLOSURE

The present invention will be further elaborated below in combination with the accompanying drawings and their markings.

In order to understand the above-mentioned purposes, features and advantages of the present invention more clearly, the present invention will be described in detail below in combination with the accompanying drawings and specific embodiments. It should be noted that, in the absence of conflict, the embodiments of this application and the features in the embodiments can be combined with each other.

The terms “first”, “second”, “third”, etc. are only used for distinguishing descriptions and should not be understood as indicating or implying relative importance.

In the description of the present invention, it should also be noted that, unless otherwise clearly stipulated and limited, the terms “set”, “install”, “connect”, “link” should be understood in a broad sense. For example, they can be fixed connections, detachable connections, or integrally connected; they can be mechanical connections or electrical connections; they can be directly connected or indirectly connected through an intermediate medium, or they can be the internal communication between two components. For ordinary technicians in this field, the specific meanings of the above terms in the present invention can be understood according to specific situations.

The specific implementation manner of the present invention will be described in detail below in combination with the accompanying drawings. It should be understood that the specific implementation manner described here is only used to illustrate and explain the present invention, and is not used to limit the present invention.

### Example 1

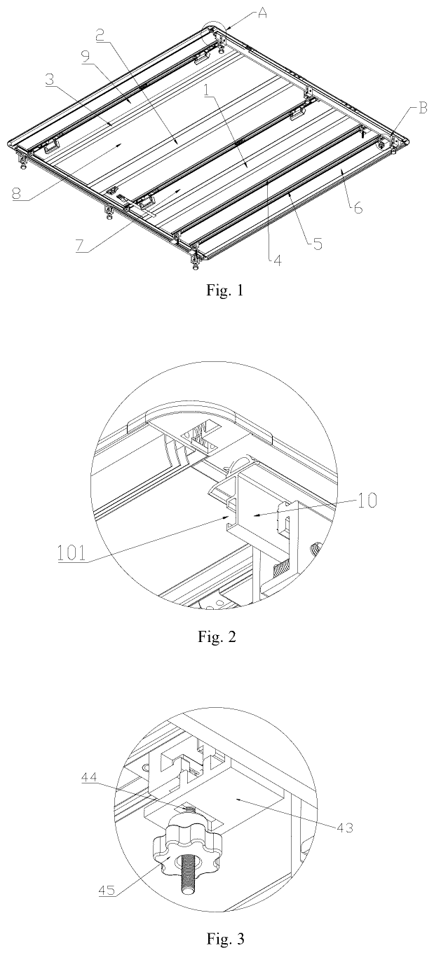

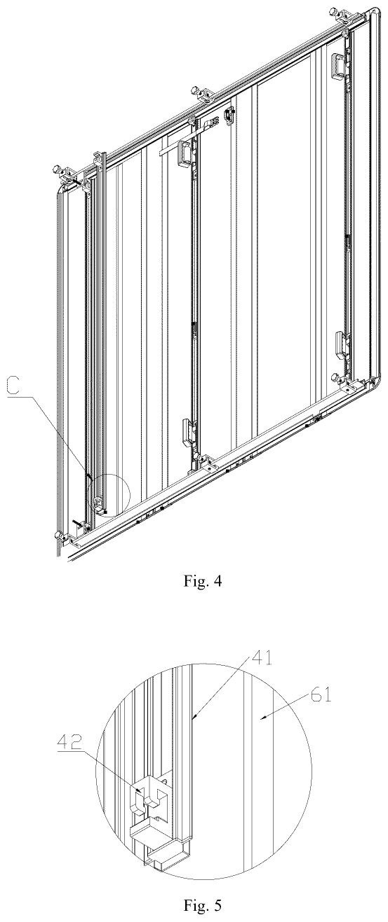

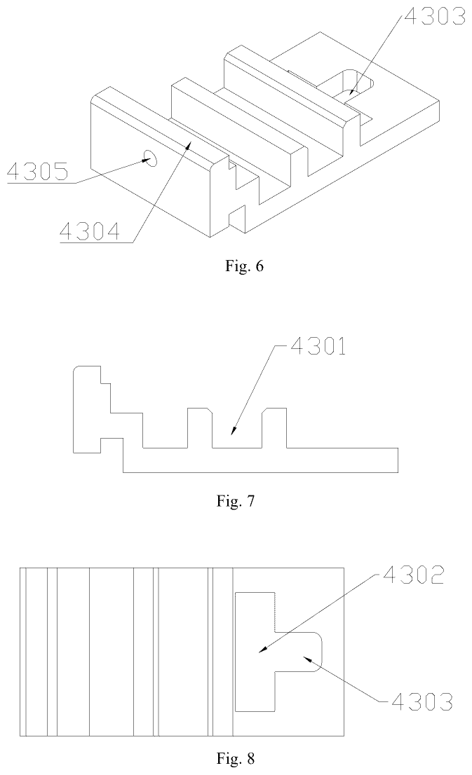

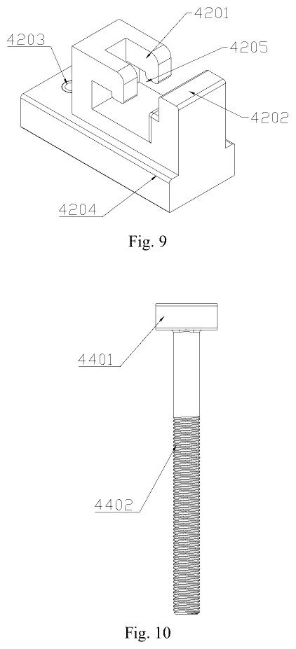

As shown in FIGS. 1-10, a large plate fixing device, it comprises a first large plate fixing block 43, a second large plate fixing block 42 and a T-shaped rod 44;

The first large plate fixing block 43 is provided with an insert block positioning groove 4301 and an insert block 4304, and the insert block 4304 is used to connect a guide rail 10 (Here, the guide rail 10 and the side rail are of an integral structure).

The second large plate fixing block 42 is provided with a clamping part 4204 and a fixing protrusion 4202, the clamping part 4204 is used to connect a car cover, and the fixing protrusion 4202 extends into the insert block positioning groove 4301 for lateral positioning;

The T-shaped rod 44 passes through the first large plate fixing block 43 and the second large plate fixing block 42, and the T-shaped rod 44 is connected with a plum blossom nut 45.

By setting the first large plate fixing block 43 and the second large plate fixing block 42, the first large plate fixing block 43 is connected to the guide rail 10, and the second large plate fixing block 42 is connected to the large plate 6 of the car cover, thus connecting the large plate 6 to the guide rail 10. A plug block positioning groove 4301 is set on the first large plate fixing block 43, and a fixing protrusion 4202 is set on the second large plate fixing block 42. The cooperation between the fixing protrusion 4202 and the plug block positioning groove 4301 is utilized to limit the position of the car cover.

Since the large plate 6 usually does not need to be opened, the connection of the large plate 6 mainly considers the stability and firmness of the connection, without considering the problem of convenient opening.

### Example 2

Based on Example 1, the first large plate fixing block 43 further comprises a tensioning hole;

The second large plate fixing block 42 further comprises a claw 4201, and in the middle of the claw 4201 is arranged a fixing block gap 4205;

The T-shaped rod 44 comprises a square head 4401 and a threaded section 4402, the square head 4401 is clamped to the claw 4201, and the square head 4401 passes through the fixing block gap 4205 and the tensioning hole.

The first large plate fixing block 43 is provided with a tensioning hole, and the second large plate fixing block 42 is provided with a claw 4201. Through the claw 4201, the square head 4401 of the T-shaped rod 44 is hooked. The T-shaped rod 44 passes through the gap 4205 between the fixing blocks and the tensioning hole. Finally, the T-shaped rod 44 is connected to a plum blossom nut 45. By screwing the plum blossom nut 45, the first large plate fixing block 43 and the second large plate fixing block 42 are tightened.

### Example 3

Based on Example 2, the tensioning hole comprises a long hole 4302 and a half-round hole 4303, and the long hole 4302 and the half-round hole 4303 are communicated with each other.

The long hole 4302 is used for T-shaped rod 44's square head 4401 to pass through. After passing through the long hole 4302, the square head 4401 needs to be moved to the claw 4201. At this time, the T-shaped rod 44 moves to the half-round hole 4303. Finally, just connect the plum blossom nut 45.

### Example 4

Based on Example 3, a car cover it comprises a plurality of cover plates. The cover plates include large plates 6, medium plates 8 and small plates 9. Two adjacent cover plates are connected by a rotating rod. The large plate 6 is glued with a first large plate fixing rod 4. The first large plate fixing rod 4 is provided with a large plate fixing groove 41, and both ends of the large plate fixing groove 41 are connected with large plate fixing devices.

This car cover is a hard car cover. The car cover is composed of multiple cover plates. The cover plates are rotationally connected to each other through rotating rods. The first large plate fixing rod 4 is glued to the bottom of the large plate 6. Different positions can be selected for installation according to requirements. It is not only convenient to connect but also firmly connected with good stability.

### Example 5

Based on Example 4, the rotating rods include the first large rotating rod 1, the second large rotating rod 2 and the small rotating rod 3.

According to the different widths of the cover plates, rotating rods of different sizes can be selected. The different sizes of the rotating rods here mainly refer to the different widths of the rotating rods.

The large plate 6 is also glued with the second large plate fixing rod 4.

By setting two large plate fixing rods 4, four-point positioning is formed on both sides of the large plate 6 to ensure the stability of the large plate 6. The structure of the second large plate fixing rod 4 can be the same as or different from that of the first large plate fixing rod 4.

The cover plates also include the secondary plate 7.

### Example 6

Based on Example 5, the car cover also includes a guide rail 10. The guide rail 10 is connected to the vehicle bucket through a clamping component. The guide rail 10 is provided with a guide rail groove 101, and the car cover is connected to the guide rail 10 through the insert block 4304.

When in use, first connect the guide rail 10 and the side rail to the vehicle bucket, and then connect the car cover to the side rail through the first large plate fixing block 43 and the second large plate fixing block 42 (since the side rail and the guide rail 10 are of an integral structure, the side rail here also refers to the guide rail 10), thus realizing the stable connection of the car cover. This connection method will not cause damage to the vehicle body.

The first large plate fixing block 43 is connected to the guide rail 10 by screw, and the screw pass through the threaded hole 4305.

The first large plate fixing block 43 can slide within the guide rail 10. After determining the specific installation position, the first large plate fixing block 43 can be fixed to the guide rail 10 by means of fastening.

Specific Working Principle: When in use, first connect the guide rail 10 to the vehicle bucket, and use the clamping components to clamp and connect the vehicle bucket and the guide rail 10. Then connect the first large plate fixing block 43 to the side rail, insert the fixing protrusion 4202 into the guide rail groove 101, so that the first large plate fixing block 43 can slide along the guide rail groove 101. According to the position of the large plate fixing groove 41, use screws to fix the first large plate fixing block 43 to the guide rail 10. Then connect the second large plate fixing block 42 to the large plate fixing groove 41 of the car cover. Next, place the car cover on the guide rail 10. Finally, make the square head 4401 of the T-shaped rod 44 pass through the long hole 4302 and connect it with the claw 4201. Finally, connect the T-shaped rod 44 to the plum blossom nut 45 to tighten the first large plate fixing block 43 and the second large plate fixing block 42.

The present invention is not limited to the above optional embodiments. Anyone can derive various other forms of products under the inspiration of the present invention. However, regardless of any changes in its shape or structure, any technical solution that falls within the scope defined by the claims of the present invention shall fall within the protection scope of the present invention.

What is claimed is:

1. A large plate fixing device comprising a first large plate fixing block, a second large plate fixing block, and a T-shaped rod, wherein
the first large plate fixing block is provided with an insert block positioning groove and an insert block, and the insert block is used to connect a guide rail;
the second large plate fixing block is provided with a clamping part and a fixing protrusion, the clamping part is used to connect a car cover, and the fixing protrusion extends into the insert block positioning groove for lateral positioning; and
the T-shaped rod passes through the first large plate fixing block and the second large plate fixing block, and the T-shaped rod is connected with a plum blossom nut.

2. The large plate fixing device according to claim 1, wherein the first large plate fixing block further comprises a tensioning hole;
the second large plate fixing block further comprises a claw, and in the middle of the claw is arranged a fixing block gap;
the T-shaped rod comprises a square head and a threaded section, the square head is clamped to the claw, and the square head passes through the fixing block gap and the tensioning hole.

3. The large plate fixing device according to claim 2, wherein the tensioning hole comprises a long hole and a half-round hole, and the long hole and the half-round hole are communicated with each other.

4. A car cover comprising:
a large plate fixing device, wherein the large plate fixing device comprises a first large plate fixing block, a second large plate fixing block, and a T-shaped rod, wherein
the first large plate fixing block is provided with an insert block positioning groove and an insert block, and the insert block is used to connect a guide rail;
the second large plate fixing block is provided with a clamping part and a fixing protrusion, the clamping part is used to connect a car cover, and the fixing protrusion extends into the insert block positioning groove for lateral positioning; and
the T-shaped rod passes through the first large plate fixing block and the second large plate fixing block, and the T-shaped rod is connected with a plum blossom nut; and
a plurality of cover plates, wherein the plurality of cover plates comprise large plates, medium plates and small plates, wherein two adjacent cover plates are connected by a rotating rod, the large plate is glued with a first large plate fixing rod, the first large plate fixing rod is provided with a large plate fixing groove, and both ends of the large plate fixing groove are connected with large plate fixing devices.

5. The car cover according to claim 4, wherein the rotating rod comprises a first large rotating rod, a second large rotating rod and a small rotating rod.

6. The car cover according to claim 4, wherein the large plate is also glued with a second large plate fixing rod.

7. The car cover according to claim 4, wherein the cover plate also comprises a secondary plate.

8. The car cover according to claim 4, wherein the car cover also comprises a guide rail, wherein the guide rail is connected to a vehicle bucket through a clamping component, the guide rail is provided with a guide rail groove, and the car cover is connected to the guide rail through the insert block.

9. The car cover according to claim 8, wherein the first large plate fixing block is connected to the guide rail by screw, and the screw pass through a threaded hole.
